(19) United States
(12) Patent Application Publication
(10) Pub. No.: US 2023/0078357 A1
(43) Pub. Date: Mar. 16, 2023

(54) RUBBER COMPOSITION FOR SUSPENSION BUSH WITH IMPROVED FATIGUE DURABILITY AND RUBBER FOR VEHICLE SUSPENSION BUSH INCLUDING THE SAME

(71) Applicants: Hyundai Motor Company, Seoul (KR); Kia Corporation, Seoul (KR)

(72) Inventors: Sung Hyun Lee, Seongnam (KR); Jae Seok Lee, Seongnam (KR)

(21) Appl. No.: 17/944,631

(22) Filed: Sep. 14, 2022

(30) Foreign Application Priority Data
Sep. 15, 2021 (KR) 10-2021-0123250

(51) Int. Cl. C08K 5/372; C08K 3/04; C08K 3/06; C08K 3/22; C08K 5/09; C08K 5/18; C08K 5/01; B60G 7/04

(52) U.S. Cl. CPC C08K 5/3725; C08K 3/04; C08K 3/06; C08K 3/22; C08K 5/09; C08K 5/18; C08K 5/01; B60G 7/04; C08K 2201/006; C08K 2003/2296; B60G 2204/41

(57) ABSTRACT

Disclosed are, inter alia, a rubber composition for suspension bush with improved fatigue durability and a rubber for a vehicle suspension bush including the same. The rubber may have increased hardness by applying a thiol-based compound as a cross-linking agent. The rubber composition may include a natural rubber, a filler including carbon black; a crosslinking agent including a thiol-based compound, an activator including zinc oxide and stearic acid, a sulfur, and a sulfur accelerator.

### CROSS-REFERENCE TO RELATED APPLICATION

This application claims under 35 U.S.C. § 119(a) the benefit of priority to Korean Patent Application No. 10-2021-0123250 filed on Sep. 15, 2021, the entire contents of which are incorporated herein by reference.

### TECHNICAL FIELD

The present invention relates to a rubber composition for suspension bush with improved fatigue durability and a rubber for a vehicle suspension bush including the same. The rubber may have increased hardness by applying a thiol-based compound as a cross-linking agent.

### BACKGROUND

Recently, in order to improve the driving performance of a customer's vehicle, a suspension of a vehicle has been developed to a complex structure with a high degree of freedom. However, the more complex a structure of the suspension, the more link contact points, and there is a limit to securing the size of a bush located at each contact point.

Particularly, the suspension bush is a part that importantly serves to suppress vibration and noise generated while the vehicle travels, and improve the comfort of the vehicle, and the main component thereof is made of rubber.

Recently, the conventional suspension bush has a problem, for example, it can be damaged by lack of fatigue durability due to the inability to withstand a high load caused by an increase in vehicle load by large vehicles and battery electric vehicles, or repeated loads. To improve such a problem, a lot of human and physical resources have been consumed.

Meanwhile, in the related art, a rubber for a suspension bush that secures fatigue durability and vibration insulation at the same time has been reported, but there is a limit in application to small and mount-type bushes with the high load applied thereto due to lack of stiffness (hardness) of the rubber.

Further, to improve this limitation, in the related art, it has been reported that a part of synthetic rubber is blended with natural rubber and additives are added thereto, thereby securing load-resistance bearing performance, but fatigue durability due to repeated loads is greatly insufficient.

Therefore, there is increasingly an urgent need for the development of a new rubber material with excellent fatigue durability as well as high hardness that the rubber constituting the suspension bush can bear the high load.

The above information disclosed in this Background section is only for enhancement of understanding of the background of the invention and accordingly it may include information that does not form the prior art that is already known in this country to a person of ordinary skill in the art.

### SUMMARY

In preferred aspect, provided are a rubber composition for a suspension bush with improved fatigue durability while maintaining high hardness characteristics and a rubber for a vehicle suspension bush including the same.

In one aspect, provided is a rubber composition including a natural rubber includes a filler including carbon black, a crosslinking agent including a thiol-based compound, an activator including zinc oxide and stearic acid, a sulfur, and a sulfur accelerator.

The rubber composition may include 100 parts by weight of the natural rubber, an amount of about 35 to 55 parts by weight of the filler, an amount of about 0.1 to 3 parts by weight of the crosslinking agent, an amount of about 4 to 9 parts by weight of the activator, an amount of about 1.5 to 2 parts by weight of the sulfur, and an amount of about 0.3 to 0.8 parts by weight of the sulfur accelerator.

The natural rubber may have a Mooney viscosity of about 55 to 65.

The carbon black may include a high abrasion furnace (HAF) with a BET specific surface area value of about 78±5 m²/g.

The thiol-based compound may include pentaerythritol tetrakis (3-mercaptopropionate).

The sulfur accelerator may include tetramethylthiuram disulfide (TMTD).

The activator may include an amount of about 3 to 7 parts by weight of the zinc oxide and an amount of about 1 to 2 parts by weight of the stearic acid, based on 100 parts by weight of the natural rubber.

The rubber composition can further include an amount of about 4.5 to 9 parts by weight of the antioxidant based on 100 parts by weight of the natural rubber.

The antioxidant may include an amount of about 1 to 3 parts by weight of the N-isopropyl-N′-phenyl-p-phenylenediamine (IPPD) and an amount of about 3.5 to 6 parts by weight of paraffin-based ozone antioxidant, based on 100 parts by weight of the natural rubber.

Further, in one aspect, provided is a rubber for a vehicle suspension bush including the rubber composition as described herein.

Also provided is a vehicle including the rubber as described herein.

The rubber composition according to various exemplary embodiments of the present invention may be formed by mixing the filler including carbon black, the crosslinking agent including the thiol-based compound, the activator including zinc oxide and stearic acid, sulfur, and the sulfur accelerator in appropriate contents, thereby maintaining high hardness and maximizing the fatigue durability.

Further, the rubber for the vehicle suspension bush according to various exemplary embodiments of the present invention can improve the problem in that parts are damaged due to the lack of fatigue durability caused by the inability to withstand high loads or the repeated loads when applied to large vehicles and battery electric vehicles with the high load.

The effects of the present invention are not limited to the aforementioned effects. It should be understood that the effects of the present invention include all effects that can be inferred from the following description.

Further provided in a rubber for a vehicle suspension bush comprising a rubber composition as disclosed herein.

Yet further provided is a vehicle suspension bush comprising the rubber composition as disclosed herein.

Still further provided is a vehicle that comprises a rubber as disclosed herein.

Yet further provided is a vehicle comprises a suspension bush that comprises a rubber composition as disclosed herein.

Other aspects of the invention are discussed infra.

### DETAILED DESCRIPTION

The above objects, other objects, features, and advantages of the present invention will be easily understood through the following preferred embodiments in conjunction with the accompanying drawings. However, the present invention is not limited to the embodiments described herein and can also be specified in other forms. Rather, the embodiments introduced herein are provided so that the content can be thorough and complete, and the spirit of the present invention can be sufficiently conveyed to those skilled in the art.

In the present specification, it should be understood that terms such as “comprise” or “have” are intended to designate that a feature, number, step, operation, component, part, or combination thereof described in the specification exists, but not to preclude the possibility of the presence or addition of one or more other features, numbers, steps, operations, components, parts, or combinations thereof.

Unless otherwise specified, it should be understood that all numbers, values, and/or expressions expressing ingredients, reaction conditions, polymer compositions, and quantities of blendings used in the present specification are approximations reflecting various uncertainties in the measurement that essentially occurs in obtaining such values among others, and therefore, expressed by the term “about” in all cases. Further, if numerical ranges are in the invention, these ranges are continuous and include all values from the minimum value to the maximum value in the range, unless otherwise indicated. Furthermore, when these ranges refer to integers, all integers from the minimum value to the maximum value are included, unless otherwise indicated.

In the present specification, when the range is described for variables, the variable will be understood as including all values within the described range including the described endpoints of the range. For example, it will be understood that a range of “5 to 10” includes not only the values of 5, 6, 7, 8, 9, and 10, but also any subranges such as 6 to 10, 7 to 10, 6 to 9, 7 to 9, and also includes any value between integers that are reasonable for the scope of the described range, such as 5.5, 6.5, 7.5, 5.5 to 8.5, and 6.5 to 9. Further, it will be understood that for example, a range of “10% to 30%” includes not only all integers including values such as 10%, 11%, 12%, and 13% and up to 30%, but also any subranges such as 10% to 15%, 12% to 18%, and 20% to 30%, and also includes any value between reasonable integers within the scope of the described range, such as 10.5%, 15.5%, and 25.5%.

It is understood that the term “automotive” or “vehicular” or other similar term as used herein is inclusive of motor automotives in general such as passenger automobiles including sports utility automotives (operation SUV), buses, trucks, various commercial automotives, watercraft including a variety of boats and ships, aircraft, and the like, and includes hybrid automotives, electric automotives, plug-in hybrid electric automotives, hydrogen-powered automotives and other alternative fuel automotives (e.g., fuels derived from resources other than petroleum). As referred to herein, a hybrid automotive is an automotive that has two or more sources of power, for example both gasoline-powered and electric-powered automotives.

The rubber composition according to the present invention may include natural rubber, a filler including carbon black, a crosslinking agent including a thiol-based compound, an activator including zinc oxide and stearic acid, sulfur, and a sulfur accelerator.

Particularly, the rubber composition further includes an antioxidant, and can include an amount of 100 parts by weight of natural rubber, an amount of about 35 to 55 parts by weight of a filler, an amount of about 0.1 to 3 parts by weight of a crosslinking aunt, an amount of about 4 to 9 parts by weight of an activator, an amount of about 1.5 to 2 parts by weight of sulfur, and an amount of about 0.3 to 0.8 parts by weight of a sulfur accelerator, and an amount of about 4.5 to 9 parts by weight of an antioxidant.

Each component constituting a rubber composition according to the present invention will be described in more detail as follows.

(A) Natural Rubber

An existing rubber composition was formed by mixing a butadiene rubber that is a synthetic rubber into the natural rubber. In particular, when the butadiene rubber is mixed with the natural rubber, hardness can be secured, but fatigue durability is reduced.

Therefore, according to various exemplary embodiments of the present invention, the natural rubber may be used alone in the rubber composition and 100 parts by weight thereof may be included. The natural rubber may provide an excellent blending dispersibility, and improve strength and fatigue durability in the rubber composition.

The natural rubber with a Mooney viscosity of about 55 to 65 may be used. The Mooney viscosity may have a value indicating the viscosity of an unvulcanized rubber, and the lower the numerical value, the better the processability of the unvulcanized rubber.

(B) Filler

The filler, as used herein, may include carbon black, and give stiffness to the rubber composition.

The filler may be included in an amount of about 35 to 55 parts by weight based on 100 parts by weight of the natural rubber in the rubber composition. When the content of the filler is less than about 35 parts by weight, the load bearing performance and durability may be unsuitable due to lack of the stiffness when the filler is used in the suspension bush. Conversely, when the content of the filler is greater than bout 55 parts by weight, vibration insulation is poor while the vehicle travels due to an excessively strong stiffness when the filler is used in the suspension bush.

Particularly, the filler may include carbon black, and a high abrasion furnace (HAF) with a BET specific surface area value of about 78±5 m²/g may be preferably used.

(C) Crosslinking Agent

The crosslinking agent, as used herein, may include a thiol-based compound. The crosslinking agent may simultaneously improve hardness and fatigue durability by increasing crosslinking density and crosslinking flexibility during crosslinking between rubber chains.

The crosslinking agent can be included in an amount of about 0.1 to 3 parts by weight based on 100 parts by weight of the natural rubber in the rubber composition. Here, when the content of the crosslinking agent is less than about 0.1 parts by weight, it is difficult to secure the hardness and fatigue durability of the rubber at the same time. Conversely, when the content of the crosslinking agent is greater than about 3 parts by weight, the material flexibility may be insufficient due to an excessively high crosslinking density between the rubber chains, and therefore, there is a possibility of brittle fracture.

The fatigue mechanism of the general rubber may propagate as cracks between rubber chains when the cracks occur at the interface between the rubber and the filler.

The crosslinking agent can improve the degree of bonding between the thiol-fillers to delay the onset of cracks in repeated fatigue durability.

Particularly, the crosslinking agent may be a thiol-based compound and Pentaerythritol tetrakis(3-mercaptopropionate) may be preferably used.

(D) Activator

The activator, as used herein, may increase the rate of the crosslinking reaction, and include zinc oxide (ZnO) and stearic acid (St-Acid).

The activator may be included in an amount of about 4 to 9 parts by weight based on 100 parts by weight of the natural rubber in the rubber composition.

Particularly, zinc oxide may be included in an amount of about 3 to 7 parts by weight based on 100 parts by weight of the natural rubber in the rubber composition. Here, when the content of the zinc oxide is less than about 3 parts by weight, crosslinking activity may be reduced and basic physical properties may not be secured, making it unsuitable for a product. Conversely, when the content of the zinc oxide is greater than about 7 parts by weight, it is unsuitable for improving fatigue durability because it induces monosulfur crosslinking (C—S—C).

In particular, the stearic acid may be included in an amount of about 1 to 2 parts by weight based on 100 parts by weight of the natural rubber in the rubber composition. Here, when the content of the stearic acid is less than about 1 part by weight, the crosslinking activity may be reduced and basic physical properties cannot be secured, making it unsuitable for the product. Conversely, when the content of the stearic acid is greater than about 2 parts by weight, it is not suitable for improving fatigue durability to induce the monosulfur crosslinking (C—S—C).

(E) Sulfur

Sulfur, as used herein, may give stiffness to the rubber composition.

It is very important that sulfur of an appropriate amount be blended in the rubber composition to induce efficient vulcanization, in which the monosulfur crosslinking (C—S—C), which is advantageous for heat resistance, is the mainstream.

The sulfur can be included in an amount of 1.5 to 2 parts by weight based on 100 parts by weight of the natural rubber in the rubber composition. Here, if the content of the sulfur is less than 1.5 parts by weight, a ratio of monosulfur (C—S—C) and disulfur (C—S—S—C) crosslinking increases, and efficient/semi-efficient vulcanization is induced as a whole and fatigue durability can be reduced due to a lack of crosslinking flexibility. Conversely, when the content of the sulfur exceeds 2 parts by weight, flexibility between chains can be hindered due to an excessively high crosslinking density, thereby reducing fatigue durability.

(F) Sulfur Accelerator

The sulfur accelerator, as used herein, may be blended with sulfur to give physical properties of the rubber material.

The sulfur accelerator may be included in an amount of about 0.3 to 0.8 parts by weight based on 100 parts by weight of the natural rubber in the rubber composition. When the content of the sulfur accelerator is less than about 0.3 parts by weight, the degree of exerting the effect of the super accelerator may be small and the mechanical stiffness of the rubber may be weakened due to a lack of crosslinking degree. Therefore, it is not possible to satisfy the required physical property conditions. Conversely, when the content of the sulfur accelerator is greater than about 0.8 parts by weight, a vulcanization rate may be over-accelerated, thereby causing the rubber to agglomerate, resulting in a scorch phenomenon that makes blending and molding difficult.

Particularly, as the sulfur accelerator, tetramethylthiuram disulfide (TMTD) may be preferably used.

(G) Antioxidant

The antioxidant may be an additive in a range that does not impair the effects of the present invention, and a known one can be used without particular limitation.

The antioxidant, as used herein, may prevent oxidation in the rubber composition, and the antioxidant may be included in an amount of about 4.5 to 9 parts by weight based on 100 parts by weight of the natural rubber in the rubber composition.

The antioxidant may include N-isopropyl-N′-phenyl-p-phenylenediamine (IPPD) and paraffin-based ozone antioxidants.

The N-isopropyl-N′-phenyl-p-phenylenediamine may be included in an amount of about 1 to 3 parts by weight based on 100 parts by weight of the natural rubber. When the content of the N-isopropyl-N′-phenyl-p-phenylenediamine is less than about 1 part by weight, the service life of the part may be shortened due to insufficient aging properties. Conversely, when the content of the N-isopropyl-N′-phenyl-p-phenylenediamine is greater than about 3 parts by weight, blooming may occur, thereby causing a problem of durability damage due to poor bonding force with the inner/outer steel pipe of the bush.

The paraffin-based ozone antioxidant may be included in an amount of about 3.5 to 6 parts by weight based on 100 parts by weight of the natural rubber. When the content of the paraffin-based ozone antioxidant is less than about 3.5 parts by weight, it is vulnerable to high temperature and ozone upon exposure, thereby causing cracks on the surface. When the content of the paraffin-based ozone antioxidant is greater than about 6 parts by weight, the mechanical stiffness of the rubber may be weakened, making it unsuitable for the required material properties, and blooming may occur, thereby weakening the bonding force with the inner/outer steel pipe of the bush.

Particularly, as the paraffin-based ozone antioxidant, Antilux 500 may be preferably used as a commercial product.

Further, provided is a rubber for the vehicle suspension bush and the rubber includes the rubber composition.

The rubber for the vehicle suspension bush has no limitation to the use field, may can improve the problem in that parts are damaged due to the lack of fatigue durability caused by the inability to withstand high loads or the repeated loads when applied to large vehicles and battery electric vehicles with high loads and therefore, can be usably applied as parts for vehicle.

### EXAMPLE

Hereinafter, the present invention will be described in more detail through the specific examples. The following examples are only examples to help the understanding of the present invention, and the scope of the present invention is not limited thereto.

### Examples 1 to 3 and Comparative Examples 1 to 10

The rubber composition was manufactured in the general method with the components and contents shown in Table 1 below.

TABLE 1

| | | | | | Compar- | Compar- | Compar- | Compar- |
|---|---|---|---|---|---|---|---|---|
| | | | | | ative | ative | ative | ative |
| | | Example | Example | Example | Example | Example | Example | Example |
| Items | | 1 | 2 | 3 | 1 | 2 | 3 | 4 |
| Polymer | NR | 100 | 100 | 100 | 100 | 100 | 100 | 100 |
| | SBR | — | — | — | — | — | — | — |
| Filler | HAF | 45 | 35 | 55 | 45 | 45 | 45 | 45 |
| (Carbon | FEF | — | — | — | — | — | — | — |
| black) | | | | | | | | |
| Cross- | PETMP | 1.0 | 1.0 | 2.0 | — | 3.5 | 1.0 | 1.0 |
| linking | | | | | | | | |
| agent | | | | | | | | |
| Activator | ZnO | 5 | 5 | 5 | 5 | 5 | 9 | 5 |
| | St- | 1.5 | 1.5 | 1.5 | 1.5 | 1.5 | 1.5 | 3.0 |
| | Acid | | | | | | | |
| Sulfur | Sulfur | 1.8 | 1.8 | 1.8 | 1.8 | 1.8 | 1.8 | 1.8 |
| Sulfur | TMTD | 0.5 | 0.5 | 0.5 | 0.5 | 0.5 | 0.5 | 0.5 |
| accelerator | | | | | | | | |
| Anti- | IPPD | 1.5 | 1.5 | 1.5 | 1.5 | 1.5 | 1.5 | 1.5 |
| oxidant | Antilux | 4.0 | 4.0 | 4.0 | 4.0 | 4.0 | 4.0 | 4.0 |
| | | | Compar- | Compar- | Compar- | Compar- | Compar- | Compar- |
| | | | ative | ative | ative | ative | ative | ative |
| | | | Example | Example | Example | Example | Example | Example |
| | Items | | 5 | 6 | 7 | 8 | 9 | 10 |
| | Polymer | NR | 100 | 100 | 100 | 100 | 100 | 80 |
| | | SBR | — | — | — | — | — | 20 |
| | Filler | HAF | 45 | 45 | 35 | 45 | — | 20 |
| | (Carbon | FEF | — | — | — | — | 20 | 15 |
| | black) | | | | | | | |
| | Cross- | PETMP | 1.0 | 1.0 | 1.0 | 1.0 | — | — |
| | linking | | | | | | | |
| | agent | | | | | | | |
| | Activator | ZnO | 5 | 5 | 5 | 5 | 3 | 5 |
| | | St- | 1.5 | 1.5 | 1.5 | 1.5 | 1.5 | 1.5 |
| | | Acid | | | | | | |
| | Sulfur | Sulfur | 1.2 | 2.5 | 1.8 | 1.8 | 0.8 | 1.8 |
| | Sulfur | TMTD | 0.5 | 0.5 | 0.2 | 0.2 | 0.6 | 0.5 |
| | accelerator | | | | | | | |
| | Anti- | IPPD | 1.5 | 1.5 | 1.5 | 0.5 | 1.5 | 1.5 |
| | oxidant | Antilux | 4.0 | 4.0 | 4.0 | 4.0 | 2.0 | 4.0 |

[Raw material component]
(1) Polymer:
Natural Rubber (NR): Mooney viscosity (ML1 + 4, natural rubber from Malaysia with 60 at 100° C., SMR CV60)
Butadiene rubber (SBR)
(2) Fillers:
Carbon Black High Abrasion Furnace (HAF) Korea Carbon Black, N330
Carbon Black Fast Extrusion Furnace (FEF) (N550)
(3) Crosslinking agent: Sigma-Aldrich, Pentaerythritol tetrakis (3-mercaptopropionate) (PETMP)
(4) Activators:
Zinc oxide (ZnO)
Stearic acid (St-Acid)
(5) Sulfur
(6) Sulfur accelerators: Dong Yang Chemical, Tetramethylthiuram Disulfide (TMTD)
(7) Antioxidant
Kumho Monsanto, N-isopropyl-N′-phenyl-p-phenylenediamine (IPPD)
Paraffin wax: LANXESS, Antilux 500

### Experimental Example

First, the rubber for the suspension bush was manufactured in the general method using the rubber compositions manufactured in Examples 1 to 3 and Comparative Examples 1 to 10. Then, the physical properties were measured by the evaluation method according to each item below. The results are shown in Table 2 below.

[Evaluation Method]

(1) Hardness (Shore A): ISO 7619-1, 18898

Suitable hardness of the rubber for the suspension bush: Hs 60±5

(2) Tensile strength and elongation: ISO 37 TYPE 1A (Speed: 500 min/min)

(3) Heat resistance: ISO 9272, 23529, 11346

(4) Fatigue durability: Measured according to the evaluation method of MS200-61

TABLE 2

| | | | | | | Compar- | Compar- | Compar- | Compar- |
|---|---|---|---|---|---|---|---|---|---|
| | | | | | | ative | ative | ative | ative |
| | | Self- | Example | Example | Example | Example | Example | Example | Example |
| Items | | standard | 1 | 2 | 3 | 1 | 2 | 3 | 4 |
| Status | Hardness | 60 ± 5 | 61 | 64 | 58 | 59 | 66 | 60 | 61 |
| physical | (Hs) | | | | | | | | |
| properties | Tensile | 250↑ | 280 | 290 | 260 | 260 | 180 | 270 | 280 |
| | strength | | | | | | | | |
| | (kg f/cm²) | | | | | | | | |
| | M100 | 20↑ | 25 | 30 | 22 | 25 | 21 | 24 | 24 |
| | (kg f/cm²) | | | | | | | | |
| Fatigue | 104× | 10.0↑ | 12.2 | 10.5 | 14.1 | 7.0 | 3.0 | 7.6 | 8.8 |
| durability | Cycle | | | | | | | | |
| Heat | Change | −2~+5 | +3 | +2 | +3 | +2 | +7 | +1 | +2 |
| resistance | in | | | | | | | | |
| (70° C. × | hardness | | | | | | | | |
| 1,000 hr) | (ΔHs) | | | | | | | | |
| | Rate | within | −14 | −13 | −13 | −15 | −25 | −8 | −12 |
| | of | −20 | | | | | | | |
| | change | | | | | | | | |
| | in | | | | | | | | |
| | tensile | | | | | | | | |
| | strength | | | | | | | | |
| | (%) | | | | | | | | |

| | | Compar- | Compar- | Compar- | Compar- | Compar- | Compar- |
|---|---|---|---|---|---|---|---|
| | | ative | ative | ative | ative | ative | ative |
| | | Example | Example | Example | Example | Example | Example |
| Items | | 5 | 6 | 7 | 8 | 9 | 10 |
| Status | Hardness | 58 | 63 | 50 | 62 | 46 | 60 |
| physical | (Hs) | | | | | | |
| properties | Tensile | 260 | 285 | 180 | 275 | 290 | 205 |
| | strength | | | | | | |
| | (kg f/cm²) | | | | | | |
| | M100 | 22 | 25 | 15 | 25 | 12 | 14 |
| | (kg f/cm²) | | | | | | |
| Fatigue | 104× | 7.2 | 9.1 | 10.8 | 11.7 | 9.2 | 5.8 |
| durability | Cycle | | | | | | |
| Heat | Change | +2 | +4 | +6 | +6 | +4 | +2 |
| resistance | in | | | | | | |
| (70° C. × | hardness | | | | | | |
| 1,000 hr) | (ΔHs) | | | | | | |
| | Rate | −10 | −17 | −25 | −25 | −15 | −10 |
| | of | | | | | | |
| | change | | | | | | |
| | in | | | | | | |
| | tensile | | | | | | |
| | strength | | | | | | |
| | (%) | | | | | | |

As shown in Table 2, Comparative Example 1 in which the thiol-based compound was not added as the crosslinking agent had relatively poor fatigue durability compared to Examples.

Further, in Comparative Example 2 in which an excessive amount of the thiol-based compound was added as the crosslinking agent, significantly low tensile strength and fatigue durability were measured, and heat resistance and hardness did not meet the required level of physical properties either.

Further, Comparative Examples 3 and 4 in which the activator was added in an excessive amount and Comparative Examples 5 and 6 in which a small amount or an excessive amount of sulfur was added had relatively low fatigue durability compared to Examples.

Further, Comparative Example 7 in which the sulfur accelerator was added in a small amount did not meet the level of physical properties required in hardness, tensile strength, and heat resistance.

Further, Comparative Example 8 in which the sulfur accelerator and the antioxidant were added in small amounts showed high rates of changes in tensile strength and hardness and therefore, the heat resistance was not good.

Meanwhile, Comparative Examples 9 and 10 showed evaluation results similar to a conventional rubber.

In Comparative Example 9, when as the filler, FEF instead of HAF was used, hardness was significantly reduced and fatigue durability was also relatively poor compared to that of Example.

Further, as shown in Comparative Example 10, the natural rubber and the butadiene rubber were mixed instead of using the natural rubber alone, and when the filler was also used by mixing HAF with FEF, tensile strength and fatigue durability were significantly reduced.

On the other hand, according to the results of Table 2, Examples 1 to 3 had a high tensile strength of 250 kg/cm² or greater while maintaining a high hardness of 55 to 65 Hs because the components were mixed in optimal contents, and the number of cycles in the fatigue durability test was 10 times or greater and therefore the fatigue durability was also excellent.

Therefore, the rubber composition according to various exemplary embodiments of the present invention can be blended in an appropriate amount of the filler including carbon black, the crosslinking agent including the thiol-based compound, the activator including zinc oxide and stearic acid, the sulfur, and the sulfur accelerator, thereby maximizing the fatigue durability of the material while maintaining the high hardness.

As described above, while the examples of the present invention have been described, those skilled in the art to which the present invention pertains will understand that the present invention can be embodied in other specific forms without departing from the technical spirit or essential features thereof. Therefore, it should be understood that the aforementioned examples are illustrative and not limited in all respects.

What is claimed is:

1. A rubber composition comprising:
a natural rubber;
a filler comprising carbon black;
a crosslinking agent comprising a thiol-based compound;
an activator comprising zinc oxide and stearic acid;
a sulfur; and
a sulfur accelerator.

2. The rubber composition of claim 1, comprising:
an amount of 100 parts by weight of the natural rubber;
an amount of about 35 to 55 parts by weight of the filler;
an amount of about 0.1 to 3 parts by weight of the crosslinking agent;
an amount of about 4 to 9 parts by weight of the activator;
an amount of about 1.5 to 2 parts by weight of the sulfur; and
an amount of about 0.3 to 0.8 parts by weight of the sulfur accelerator,
based on 100 parts by weight of the natural rubber.

3. The rubber composition of claim 1,
wherein the natural rubber has a Mooney viscosity of an amount of about 55 to 65.

4. The rubber composition of claim 1,
wherein the carbon black comprises: a high abrasion furnace (HAF) with a BET specific surface area value of about 78±5 m²/g.

5. The rubber composition of claim 1, wherein the thiol-based compound comprises pentaerythritol tetrakis (3-mercaptopropionate).

6. The rubber composition of claim 1, wherein the sulfur accelerator comprises tetramethylthiuram disulfide (TMTD).

7. The rubber composition of claim 1, wherein the activator comprises:
based on 100 parts by weight of the natural rubber,
an amount of about 3 to 7 parts by weight of the zinc oxide; and
an amount of about 1 to 2 parts by weight of the stearic acid.

8. The rubber composition of claim 1, further comprising:
an amount of about 4.5 to 9 parts by weight of the antioxidant based on 100 parts by weight of the natural rubber.

9. The rubber composition of claim 8, wherein the antioxidant comprises:
based on 100 parts by weight of the natural rubber,
an amount of about 1 to 3 parts by weight of the N-isopropyl-N′-phenyl-p-phenylenediamine (IPPD); and
an amount of about 3.5 to 6 parts by weight of paraffin-based ozone antioxidant.

10. A rubber for a vehicle suspension bush comprising the rubber composition of claim 1.

11. A vehicle suspension bush comprising the rubber composition of claim 1.

12. A vehicle comprising the rubber of claim 10.

13. A vehicle comprising the suspension bush of claim 11.
